(19) United States
(12) Patent Application Publication
(10) Pub. No.: US 2007/0204910 A1
(43) Pub. Date: Sep. 6, 2007

(54) Fountain for viscous food substances

(76) Inventor: Man-Yan Chan, Kowloon (CN)

Correspondence Address: ALIX YALE & RISTAS LLP, 750 MAIN STREET, SUITE 1400, HARTFORD, CT, 06103, US

(21) Appl. No.: 11/508,448

(22) Filed: Aug. 23, 2006

(30) Foreign Application Priority Data
Mar. 1, 2006 (CN) 200620004232.5

(51) Int. Cl. F16K 11/00

(52) U.S. Cl. 137/243

(57) ABSTRACT

A fountain includes a bowl for containing a viscous substance such as chocolate sauce. A pair of riser tubes extends upwardly from the bowl. Each riser tube has an inlet to receive the viscous substance from the bowl and a pair of augers, one within each respective riser tube. A gearbox is driven by a motor and includes a pair of output gears both driven to rotate in the same direction. Each output gear is connected to a respective one of the augers.

### BACKGROUND OF THE INVENTION

The present invention relates to fountains for viscous food substances such as chocolate sauce (also known as chocolate fondue). More particularly, although not exclusively, the invention relates to such a fountain of the style that might be used in hotel dining rooms or buffets for example.

Known viscous substance fountains comprise a bowl from which a vertical riser tube extends and in which an auger is rotated by a motor to draw the substance from the bowl to an outlet at the top of the riser tube.

Such devices as described above are limited to a single auger/riser tube and this may present reliability problems.

### OBJECT OF THE INVENTION

It is an object of the present invention to overcome or substantially ameliorate the above disadvantage and/or more generally to provide an improved viscous substance fountain.

### DISCLOSURE OF THE INVENTION

There is disclosed herein a fountain, comprising:
a bowl for containing a viscous food substance,
a pair of riser tubes extending upwardly from the bowl, each riser tube having an inlet to receive viscous substance from the bowl,
a pair of augers, one within each respective riser tube,
an enclosure beneath the bowl,
a motor housed within the enclosure, and
a gearbox driven by the motor and comprising a pair of output gears both driven to rotate in the same direction, wherein each output gear is connected to a respective one of the augers.

Preferably, the gearbox comprises a central shaft upon which a centre gear and centre pinion are mounted, and wherein the motor comprises an output shaft that drives the centre gear, and wherein the centre pinion engages with both output gears.

Preferably, the fountain further comprises a lip at an upper extremity of the riser tubes over which the viscous substance pours.

Preferably, the fountain further comprises one or more deflectors surrounding the riser tubes for deflecting the viscous substance falling from the lip away from the riser tubes.

### BRIEF DESCRIPTION OF THE DRAWING

A preferred form of the present invention will now be described by way of example with reference to

FIG. 1 which is a schematic cross-sectional elevation of a viscous substance fountain.

### DESCRIPTION OF THE PREFERRED EMBODIMENT

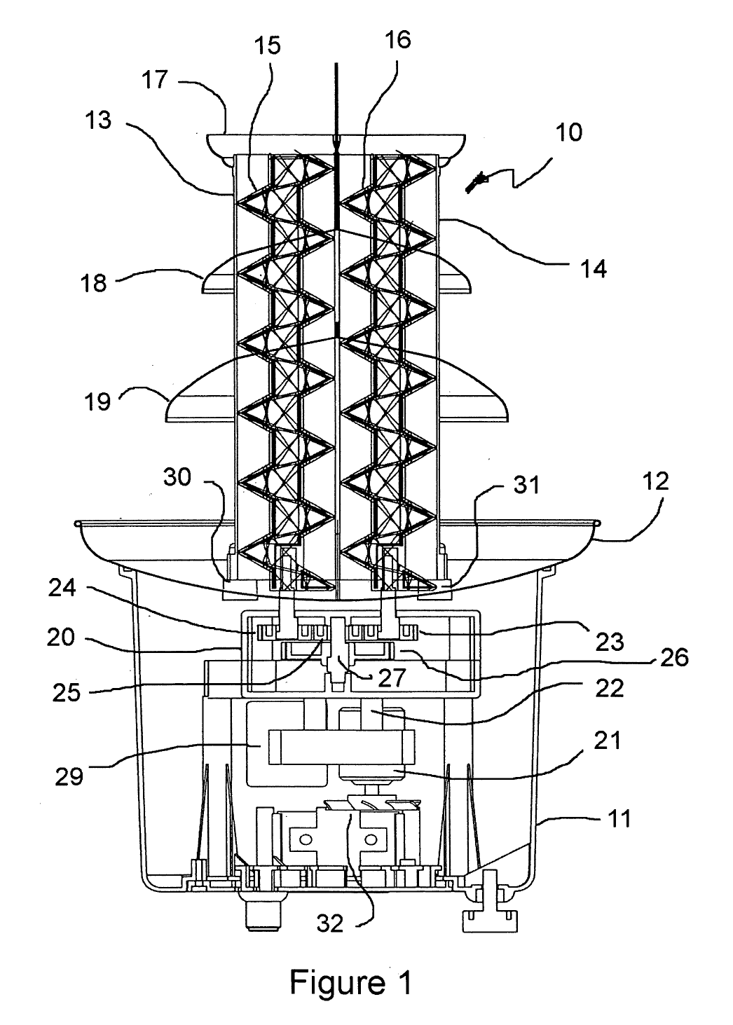

In FIG. 1 there is depicted schematically a viscous substance fountain 10 which would typically be used to circulate a viscous edible substance such as chocolate fondue for example. The fountain comprises a base enclosure 11 having feet at the bottom by which the base could sit upon a serving bench or buffet counter. Within the base enclosure 11 there is an electric motor 21 having an output shaft 22 which extends downward to rotate a cooling impeller 32 and upward to drive gears within a gearbox 20.

Situated upon the base enclosure 11 is a bowl 12 from which the viscous substance is served. From the centre of the bowl there extends upwardly a pair of riser tubes 13 and 14. Within the riser tube 13 there is provided an auger 15 and within the riser tube 14 there is an identical auger 16. At the top of the riser tubes 13 and 14 there is a lip 17. Beneath the lip 17 and also extending about the riser tubes is an upper deflector 18 and a lower deflector 19 which is broader than the upper deflector.

At the bottom of each riser tube there is an inlet 30, 31.

Within the gearbox 20 there is provided a central shaft 27 upon which there is fixed a main gear 26 and a pinion 25. The motor output shaft has a small gear (not shown) that meshes with the teeth of the main gear 26.

Directly beneath each auger and fixed to rotate therewith is a respective auger gear 23, 24. Each of these auger gears is driven by the pinion 25 and therefore rotate in the same direction as each other. As a result, identical augers can be used.

In use, the motor 21 is activated and this causes the impeller 32 to rotate quickly to cool the motor. The main gear 26 rotates relatively slowly. The pinion 25 rotates at the same speed as the main gear 26 and causes rotation of the augers as described. A viscous substance such as chocolate fondue within the bowl 12 is drawn into each riser tube via its respective inlet 30, 31 and then is drawn upwardly by the rotating augers to exude over the lip 17 from where it falls like water over a weir to be deflected by both the upper deflector 18 and lower deflector 19 and back into the bowl 12. An item such as a strawberry can then be dipped into the viscous substance at the bowl 12.

An advantage of the present invention is that should one of the augers and rising tubes become blocked or empty, the other can still function as normal.

It should be appreciated that modifications and alterations obvious to those skilled in the art are not to be considered as beyond the scope of the present invention. For example, rather than providing a base closure as depicted, the fountain could be provided as a bench top fitting in which the bowl 12 would be positioned substantially at bench level, with the gearbox and motor located below the bench top.

1. A fountain, comprising:
a bowl for containing a viscous food substance,
a pair of riser tubes extending upwardly from the bowl, each riser tube having an inlet to receive viscous substance from the bowl,
a pair of augers, one within each respective riser tube,
an enclosure beneath the bowl,
a motor housed within the enclosure, and
a gearbox driven by the motor and comprising a pair of output gears both driven to rotate in the same direction, wherein each output gear is connected to a respective one of the augers.

2. The fountain of claim 1, wherein the gearbox comprises a central shaft upon which a centre gear and centre pinion are mounted, and wherein the motor comprises an output shaft that drives the centre gear, and wherein the centre pinion engages with both output gears.

3. The fountain of claim 1, further comprising a lip at an upper extremity of the riser tubes over which the viscous substance pours.

4. The fountain of claim 3, further comprising one or more deflectors surrounding the riser tubes for deflecting the viscous substance falling from the lip away from the riser tubes.
